(19) United States
(12) Patent Application Publication
(10) Pub. No.: US 2026/0078952 A1
(43) Pub. Date: Mar. 19, 2026

(54) ELECTRODE PLATE DRYING FURNACE

(71) Applicant: SAMSUNG SDI CO., LTD., Yongin-si (KR)

(72) Inventor: Minho KIM, Yongin-si (KR)

(21) Appl. No.: 19/175,121

(22) Filed: Apr. 10, 2025

(30) Foreign Application Priority Data
Sep. 13, 2024 (KR) 10-2024-0125939

(51) Int. Cl. F26B 13/10; F26B 13/14

(52) U.S. Cl. CPC F26B 13/108; F26B 13/14

(57) ABSTRACT

An electrode plate drying furnace includes a supply pipe through which a fluid is introduced from outside, a drying duct connected to the supply pipe, a plurality of nozzles connected to a bottom of the drying duct and configured to direct at least a portion of the fluid toward an electrode substrate being transported below the electrode plate drying furnace. The furnace also includes a distribution plate auxiliary apparatus disposed between the distribution plate and at least one of nozzles within the drying duct. A composite portion for an electrode plate is applied to the electrode substrate. The drying duct is configured to allow the fluid to move through the drying duct. A distribution plate is connected to a lower end of the supply pipe within the drying duct and is configured to distribute the fluid flowing from the supply pipe toward the plurality of nozzles.

### CROSS REFERENCE TO RELATED APPLICATION

This application claims priority under 35 U.S.C. § 119 to Korean Patent Application No. 10-2024-0125939, filed in the Korean Intellectual Property Office on Sep. 13, 2024, the entire contents of which are hereby incorporated by reference.

### BACKGROUND

### 1. Field

The present disclosure relates to an electrode plate drying furnace for manufacturing secondary batteries.

### 2. Description of the Related Art

A process of manufacturing an electrode of a secondary battery includes a process of applying an electrode composite to an electrode substrate and a process of drying the electrode composite. To dry the electrode composite, an electrode drying furnace is generally used. The process of drying the electrode composite may refer to a process of removing solvent from the electrode composite paste. A process of drying the electrode composite using a plate drying furnace may include transferring an electrode substrate having an electrode composite applied to a surface thereof to a position below a nozzle of a plate drying furnace and blowing hot air to the electrode composite on the electrode substrate to evaporate and remove solvents such as N-methyl-2-pyrrolidone (NMP) or water from the electrode composite.

In most electrode plate drying furnaces, the nozzle that blows hot air onto the electrode plate may itself act as a resistance to uniform distribution or dispersion of the hot air supplied. In addition, when a distance between the bottom nozzle and the electrode plate is reduced to increase drying efficiency, hot air may come into contact with the electrode plate before there is a flow of hot air sufficient to create uniform distribution or dispersion of the hot air supplied. In addition, when the hot air is supplied into the electrode plate drying furnace, the air may not uniformly distribute throughout the bottom nozzle and may reach the nozzle while remaining biased toward the air introduction area. Accordingly, uneven drying of the electrode plate may lead to poor electrode plate quality and safety issues for secondary batteries.

The above information disclosed in this Background section is for enhancement of understanding of the background of the present disclosure, and therefore, it may contain information that does not constitute related (or prior) art.

### SUMMARY

An objective of the present disclosure is to provide an electrode plate drying furnace for solving the above-described problems.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to one or more embodiments of the present disclosure, an electrode plate drying furnace includes a supply pipe through which a fluid can be introduced, a drying duct connected to the supply pipe, the drying duct configured to allow the fluid to move therethrough, a plurality of nozzles connected to a bottom of the drying duct, and configured to direct at least a portion of the fluid toward an electrode substrate which is being transported and to which a composite portion for an electrode plate is applied, a distribution plate connected to a lower end of the supply pipe within the drying duct, the distribution plate being configured to distribute the fluid flowing from the supply pipe toward the nozzles, and a distribution plate auxiliary apparatus disposed between the distribution plate and at least one of the nozzles within the drying duct, and the distribution plate auxiliary apparatus being configured to change a direction of distribution of the distributed portion of the fluid.

In an embodiment, the distribution plate auxiliary apparatus may be connected to the lower end of the supply pipe.

In an embodiment, the distribution plate auxiliary apparatus may be connected to an inner wall of the drying duct.

In an embodiment, the distribution plate auxiliary apparatus may include a plurality of holes.

In an embodiment, the distribution plate auxiliary apparatus may have a plate-shaped structure.

In an embodiment, the distribution plate auxiliary apparatus may be formed by being folded about a centerline passing through a central portion of the distribution plate auxiliary apparatus so that the distribution plate auxiliary apparatus is folded toward the electrode substrate to which the composite portion for the electrode plate is applied.

In an embodiment, the centerline may be parallel to a transverse direction of the electrode plate drying furnace.

In an embodiment, the distribution plate auxiliary apparatus may have a conical shape which is recessed in an opposite direction to a direction toward the electrode substrate to which the composite portion for the electrode plate is applied.

In an embodiment, the maximum width of the distribution plate auxiliary apparatus may be 0.8 to 1.2 times the diameter of the supply pipe.

In an embodiment, the distribution plate auxiliary apparatus may include a first distribution plate auxiliary apparatus disposed between the supply pipe and at least one of the nozzles, and a second distribution plate auxiliary apparatus disposed between the first distribution plate auxiliary apparatus and at least one of the nozzles.

In an embodiment, the maximum width of the distribution plate auxiliary apparatus may be less than the maximum width of the distribution plate.

In an embodiment, the distribution plate may include a plurality of holes.

In an embodiment, the distribution plate may include a connection surface connected to the lower end of the supply pipe and connected to inclined surfaces surrounding the connection surface, the inclined surfaces being connected to and inclined downward from the connection surface.

In an embodiment, each of the nozzles may include a plurality of holes at a bottom of the nozzle.

In an embodiment, the plurality of nozzles is arranged in a longitudinal direction of a bottom of the drying duct.

In an embodiment, each of the nozzles may have a cross-sectional area that decreases in a direction toward the electrode substrate to which the composite portion for the electrode plate is applied.

In an embodiment, the electrode plate drying furnace may further include conveyance rollers configured to transport the electrode substrate in a longitudinal direction of a bottom of the drying duct when the electrode substrate is spaced apart from the bottom of the drying duct.

In an embodiment, the length of each of the nozzles in a longitudinal direction may be equal to or longer than the length of the composite portion for the electrode plate in a transverse direction.

In an embodiment, the center of the supply pipe, the center of the distribution plate, and the center of the distribution plate auxiliary apparatus may overlap with the center of the drying duct.

According to one or more embodiments of the present disclosure, an electrode plate drying furnace includes a supply pipe through which fluid is introduced, a drying duct connected to the supply pipe, and configured to allow the fluid to move therethrough, conveyance rollers configured to transport an electrode substrate to which a composite portion is applied in a longitudinal direction of a bottom of the drying duct when the electrode substrate is spaced apart from the bottom of the drying duct, a plurality of nozzles arranged in the longitudinal direction of the bottom of the drying duct, the nozzles being configured to direct at least a portion of the fluid toward the electrode substrate being transported, a distribution plate including, within the drying duct, a connection surface connected to a lower end of the supply pipe and to inclined surfaces, the inclined surfaces surrounding the connection surface and inclining downward from the connection surface, the connection surface and the inclined surfaces configured to distribute the fluid in a direction toward the nozzles, and a distribution plate auxiliary apparatus disposed between the distribution plate and at least one of the nozzles within the drying duct, the distribution plate auxiliary apparatus being configured to change a direction of distribution of at least a portion of the distributed fluid.

According to some embodiments of the present disclosure, a large aspect ratio of the drying duct of the electrode plate drying furnace may prevent a phenomenon of air not being distributed to left and right ends of the drying duct.

According to some embodiments of the present disclosure, a phenomenon of air being trapped below the distribution plate within the drying duct of the electrode plate drying furnace may be prevented.

According to some embodiments of the present disclosure, a phenomenon of air flowing back without being directly sprayed due to a wide width of the nozzle of the electrode plate drying furnace may be prevented.

According to some embodiments of the present disclosure, a phenomenon of air flowing along a side surface of a central nozzle of the plurality of nozzles so as not to contact the central portion of a composite portion of the electrode plate may be prevented.

According to some embodiments of the present disclosure, a drying performance of the electrode plate drying furnace may be improved, and an entire surface of the composite portion of the electrode plate may be uniformly dried.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is a side view of an electrode plate drying furnace according to embodiments of the present disclosure, viewed in in the longitudinal direction (i.e., in the x direction).

FIG. 2 is another side view of the electrode plate drying furnace shown in FIG. 1, viewed in the transverse direction (i.e., in the y direction).

FIG. 3 is a plan view of the electrode plate drying furnace according to embodiments of the present disclosure.

FIG. 4 is an isometric view partially of the nozzles and the electrode according to embodiments of the present disclosure.

FIG. 5 shows an isometric view of a supply pipe and a distribution plate and a top view of the distribution plate according to embodiments of the present disclosure.

FIG. 6 is a perspective view of a distribution plate auxiliary apparatus folded about a centerline according to some embodiments of the present disclosure.

FIG. 7 is a perspective view of a distribution plate auxiliary apparatus having a conical shape according to some embodiments of the present disclosure.

FIG. 8 is a perspective view of a distribution plate auxiliary apparatus having a rectangular plate-shaped structure according to some embodiments of the present disclosure.

FIG. 9A is a schematic view of fluid flow in the electrode plate drying furnace according to some embodiments of the present disclosure.

FIG. 9B is another schematic view of fluid flow in the electrode plate drying furnace according to some embodiments of the present disclosure.

FIG. 10A is a vector field of a fluid flow and flow velocity in the electrode plate drying furnace according to some embodiments of the present disclosure.

FIG. 10B is another vector field of a fluid flow and flow velocity in the electrode plate drying furnace according to some embodiments of the present disclosure.

FIG. 10C is another vector field of a fluid flow and flow velocity in the electrode plate drying furnace according to some embodiments of the present disclosure.

FIG. 11A is a pressure field on the surface of the electrode plate of the drying furnace according to some embodiments of the present disclosure.

FIG. 11B is another pressure field on the surface of the electrode plate of the drying furnace according to some embodiments of the present disclosure.

FIG. 11C is another pressure field on the surface of the electrode plate of the drying furnace according to some embodiments of the present disclosure.

### DETAILED DESCRIPTION OF THE EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the apparatus in use or operation in addition to the orientation depicted in the figures. For example, if the apparatus in the figures is turned over, elements described as “below” or “beneath” other elements or features would then be oriented “above” or “over” the other elements or features. Thus, the term “below” may encompass both an orientation of above and below. The apparatus may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

As used herein, the term “removing” includes reducing the residual amount of solvent to a predetermined standard level or less, and does not necessarily mean removing the solvent completely.

Terms used herein are intended to describe embodiments of the present disclosure and are not intended to limit the present disclosure.

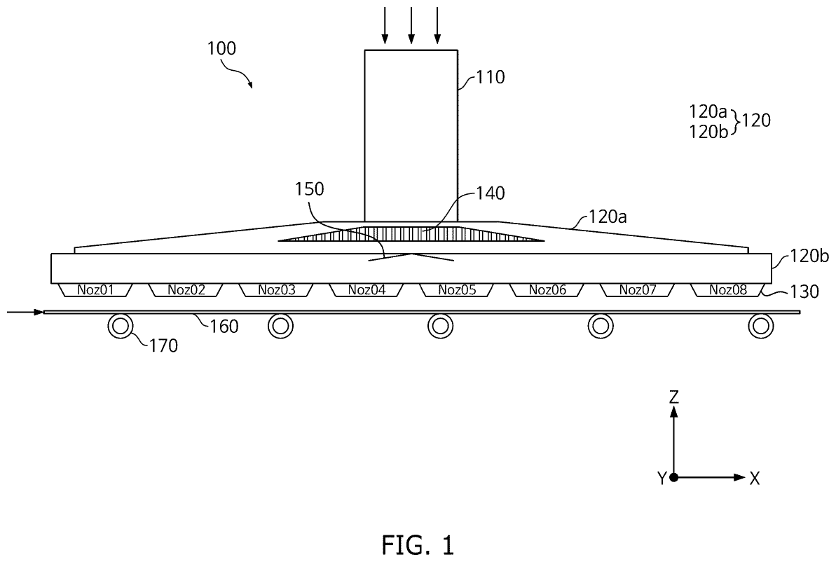

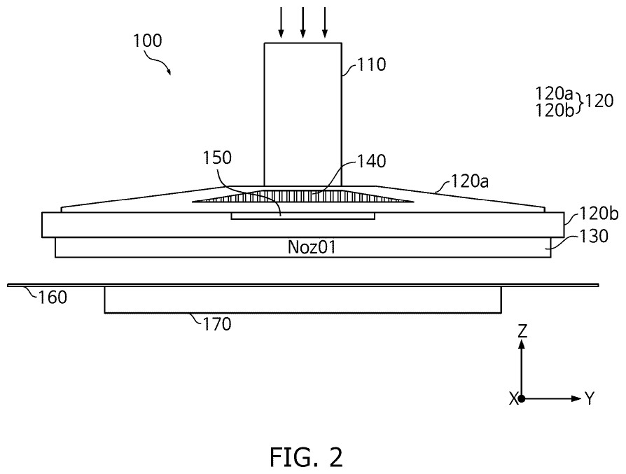

FIG. 1 is a side view of an electrode plate drying furnace according to embodiments of the present disclosure, viewed in in the longitudinal direction (i.e., in the x direction). FIG. 2 is a different side view of the electrode plate drying furnace shown in FIG. 1, viewed in the transverse direction (i.e., in the y direction). In FIGS. 1 and 2, arrows indicate a direction of fluid introduction.

An electrode plate drying furnace 100 may include a supply pipe 110 through which fluid is introduced from outside, a drying duct 120 connected to the supply pipe 110 and configured to allow the fluid to move therethrough, a plurality of nozzles 130 connected to the bottom of the drying duct 120, a distribution plate 140 connected to the lower end of the supply pipe 110 within the drying duct 120, and a distribution plate auxiliary apparatus 150 disposed between the distribution plate 140 and at least one of the plurality of nozzles 130 within the drying duct 120.

The drying furnace 100 may further include conveyance rollers 170 configured to transport an electrode substrate in the longitudinal direction (i.e., in the x direction) of the bottom of the drying duct 120. The electrode substrate may be spaced apart from the bottom of the drying duct 120. Within the drying furnace 100, the electrode substrate may be transported by conveyance rollers 170 in a roll-to-roll manner, and the plurality of nozzles 130 may be connected to the bottom of the drying duct 120 to spray fluid in a direction toward the electrode substrate to dry the composite applied to the electrode substrate.

Although not shown, a secondary battery may be formed, for example, by embedding an electrode assembly (configured to be charged and discharged) and an electrolyte into a case and disposing a cap assembly electrically connected to the electrode assembly in an open area of the case. The electrode assembly may be formed by jelly rolling, or repeatedly stacking, negative and positive electrodes that are stacked with a separator provided therebetween. The drying furnace 100 may dry a composite portion applied to the electrode substrate that forms the negative and positive electrodes of the secondary battery.

Although not shown, in some embodiments, the drying furnace 100 may be disposed between an unwinding part and a winding part, such that an electrode plate 160 supplied by the unwinding part may be dried in the drying furnace 100 before being supplied to the winding part.

Fluid supplied through the supply pipe 110 may be air that is heated by a heater using a supply fan and sent into the drying duct 120 as hot air.

The supply pipe 110 is a component in the shape of a pipe that supplies fluid into the drying duct 120, and the shape or material thereof is not particularly limited. However, the supply pipe 110 may be disposed above the drying duct 120 in the height direction (i.e., in the z direction), at a position corresponding to the center of the drying duct 120. This configuration may be suitable for efficiently distributing (or dispersing) fluid entering the drying duct 120 that has a large aspect ratio.

Referring to FIG. 1, the drying duct 120 may include an upper duct 120a and a lower duct 120b. The upper duct 120a may be connected to the lower end of the supply pipe 110, and the lower duct 120b may be connected to the lower end of the upper duct 120a. The upper duct 120a and the lower duct 120b share an internal space, and fluid introduced from outside may pass through the upper duct 120a to reach the lower duct 120b. For example, the upper duct 120a may include a horizontal surface connecting to the supply pipe 110 and a downwardly inclined surface surrounding a horizontal plane.

As shown in FIG. 1, the inclined surface may have a substantially trapezoidal shape when viewed from a side of the drying furnace in the longitudinal direction (i.e., in the x direction). In addition, the lower duct 120b may be connected to the lower end of the inclined surface of the upper duct 120a and may provide a space for sufficient fluid to flow. The lower duct 120b may also have a substantially rectangular shape having a longer length, for example, in the longitudinal direction of the electrode plate 160 (i.e., in the x direction).

The plurality of nozzles 130 may be connected to the bottom of the lower duct 120b and may be configured to spray at least a portion of the introduced fluid toward the electrode substrate being transported. The electrode substrate may be transported by the conveyance rollers 170 below the plurality of nozzles 130, and when the drying furnace 100 is fixed, a drying operation may be performed by removing a portion of a solvent from the composite portion 160a of the electrode plate 160, the composite portion 160a being transported to the lower end of the drying furnace 100. As used herein, the term “removing” includes reducing the residual amount of solvent to a predetermined standard level or less, and does not necessarily mean removing the solvent completely

In addition, a plurality of drying furnaces 100 may be arranged in the longitudinal direction (i.e., in the x direction) of the electrode plate 160, the electrode plate 160 being transported between the unwinding part and the winding part, so that the electrode plate drying process may proceed continuously. For example, the drying furnaces 100 may be arranged such that six to twelve drying furnaces 100 are horizontally connected, and each of the drying furnaces 100 may include the drying duct 120 having a longer length in the longitudinal direction of the electrode plate 160 (i.e., in the x direction).

Referring to FIG. 1, the plurality of nozzles 130 may be arranged in the longitudinal direction of the bottom of the drying duct 120 (i.e., in the x direction). Referring to FIG. 2, a single nozzle 130 may be disposed in the transverse direction of the drying duct 120 (i.e., in the y direction). In some embodiments, a perforated plate having a plurality of holes may be disposed at a bottom of each nozzle of the plurality of nozzles 130. Due to a resistance to fluid flow created by the structure of the plurality of nozzles 130 and the perforated plate, fluid that has passed through the lower duct 120b may be distributed when sprayed onto the electrode plate 160 instead of being sprayed unevenly. In some embodiments, the number of nozzles 130 may range from 8 to 16 to allow a sufficient distribution of fluid in the longitudinal direction (i.e., in the x direction) of the bottom of the lower duct 120b, but other embodiments are not limited thereto, as the nozzles 130 may be of any number that allows for a sufficient distribution of fluid in the longitudinal direction of the drying duct 120 (i.e., in the x direction) when the fluid is sprayed onto the electrode plate 160. However, for ease of illustration, the present disclosure will be described using an example where the number of the plurality of nozzles 130 is eight (8).

Even when a small number of nozzles are provided at the bottom of the drying duct 120, and each of the plurality of nozzles 130 has a longer length in the longitudinal direction (i.e., in the x direction) of the drying furnace 100, the distribution plate 140 and the distribution plate auxiliary apparatus 150 may be desirably provided within the drying duct 120 to maximize the effect of increasing the flow distribution by the plurality of nozzles 130, as described above.

The drying furnace 100 may include the distribution plate 140 within the drying duct 120. The distribution plate 140 may be connected to the lower end of the supply pipe 110 and configured to distribute fluid flowing from the supply pipe 110 in a direction toward the plurality of nozzles 130. The distribution plate 140 may change the fluid flow, thus allowing the fluid to spread throughout the interior of the drying duct 120. The fluid may collide with the distribution plate 140 to partially change the direction of the flow or may pass through the distribution plate 140 and pass through a position below the distribution plate 140. Thus, in some embodiments, the distribution plate 140 may have the shape of a plate with a plurality of striped holes perforated therein, as shown in FIGS. 1 and 2, but other embodiments are not limited thereto.

The distribution plate 140 may be disposed in a central portion of the drying furnace 100. For example, the distribution plate 140 may be disposed over a central nozzle (e.g., Noz04 or Noz05) of the plurality of nozzles 130 arranged in the longitudinal direction of the drying furnace 100 (i.e., in the x direction).

The drying furnace 100 may include the distribution plate 140 and the distribution plate auxiliary apparatus 150 within the drying duct 120. The distribution plate auxiliary apparatus 150 and the distribution plate auxiliary apparatus 150 may be disposed between at least one of the plurality of nozzles 130 and may be configured to change the direction of distribution of at least a portion of the fluid distributed by the distribution plate 140. For example, the distribution plate auxiliary apparatus 150 may be disposed between the distribution plate 140 and the central nozzle (e.g., Noz04 or Noz05). The distribution plate auxiliary apparatus 150 may change a direction of distribution of a portion of the fluid accumulated below the distribution plate 140 using the distribution plate 140.

Referring to FIGS. 1 and 2, the distribution plate auxiliary apparatus 150 may include, but is not limited to, a plate having opposite side surfaces thereof bent downward relative to a centerline extending through the center portion.

The distribution plate auxiliary apparatus 150 may be connected to a lower end of the supply pipe 110. For example, the distribution plate auxiliary apparatus 150 may be arranged to be connected to a plurality of circular rods (not shown) connected to the distribution plate 140 and may be suspended from a ceiling of the distribution plate 140. In another example, the circular rods may be connected to a ceiling surface of the upper duct 120a without being connected to the distribution plate 140, and the distribution plate auxiliary apparatus 150 may be connected to the circular rods. In some embodiments, the connection between the circular rods and the distribution plate auxiliary apparatus 150 may be accomplished by welding, but other embodiments are not limited thereto.

In another example, although not shown, the distribution plate auxiliary apparatus 150 may be connected to an inner wall of the drying duct 120, and, thus, the distribution plate auxiliary apparatus may have a larger size than the distribution plate auxiliary apparatus 150 shown in FIGS. 1 and 2. The width of the distribution plate auxiliary apparatus 150 may be designed to be substantially the same as the width of the drying duct 120 such that an end of the distribution plate auxiliary apparatus 150 may be connected to the inner wall of the drying duct 120 by welding or the like. The end of the distribution plate auxiliary apparatus 150 may be connected to the inner wall of the upper duct 120a or the inner wall of the lower duct 120b, depending on a shape of the distribution plate auxiliary apparatus 150. The above descriptions of embodiments describing connections of the distribution plate auxiliary apparatus 150 should be construed as non-limiting, other embodiments thereof are compatible with the present disclosure as long as a connection for the distribution plate auxiliary apparatus 150 is strong enough to withstand the pressure of the fluid.

The distribution plate auxiliary apparatus 150 may change fluid flow that has passed through the distribution plate 140 to facilitate fluid distribution in the longitudinal direction (i.e., in the x direction) within the drying duct 120 so that the fluid may be uniformly supplied to the upper portions of all of the plurality of nozzles 130. Furthermore, the distribution plate auxiliary apparatus 150 may prevent the central nozzle (e.g., Noz04 or Noz05) from being supplied with fluid at a high flow rate.

Although not shown, in the drying furnace 100 according to embodiments, the distribution plate auxiliary apparatus 150 may include a first distribution plate auxiliary apparatus disposed between the supply pipe 110 and at least one of the plurality of nozzles 130 and a second distribution plate auxiliary apparatus disposed between the first distribution plate auxiliary apparatus and at least one of the plurality of nozzles 130. The first distribution plate auxiliary apparatus may be disposed between the central nozzle (e.g., Noz04 or Noz05) and the distribution plate, for example. In addition, the second distribution plate auxiliary apparatus may be disposed between the central nozzle (e.g., Noz04 or Noz05) and the first distribution plate auxiliary apparatus described above. Accordingly, a distribution direction of a portion of the fluid accumulating below the distribution plate 140 may be changed twice.

The drying furnace 100 may be disposed in a room with a constant temperature and humidity such that the drying quality of the electrode plate 160 may be controlled only by the drying furnace 100.

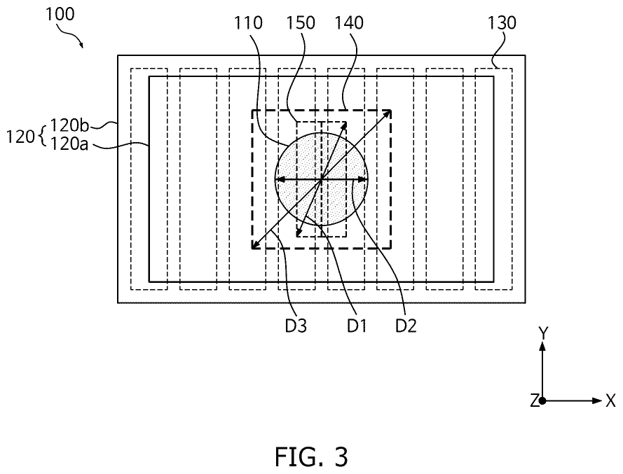

FIG. 3 is a plan view of the electrode plate drying furnace according to embodiments of the present disclosure. FIG. 3 shows a position and size of each of the components in the drying furnace 100.

The maximum width D1 of the distribution plate auxiliary apparatus 150 may be from 0.8 to 1.2 times the diameter D2 of the supply pipe 110. When the width of the distribution plate auxiliary apparatus 150 is within the above range, the fluid flow entering the drying duct 120 through the supply pipe 110 may be effectively distributed by the distribution plate auxiliary apparatus 150. Thus, the fluid entering from the supply pipe 110 and initially distributed by the distribution plate 140 may collide with the distribution plate auxiliary apparatus 150 so that most of a flow thereof is changed. When the width of the distribution plate auxiliary apparatus 150 is small, it may be difficult to change the fluid flow against a pressure of a fluid entering from the supply pipe 110. When the width of the distribution plate auxiliary apparatus 150 is large, there may be a greater resistance to a fluid accumulating below the distribution plate 140, thereby making it difficult for the fluid distribution to occur in the longitudinal direction (i.e., in the x direction) of the drying furnace 100.

The maximum width D1 of the distribution plate auxiliary apparatus 150 may be smaller than the maximum width D3 of the distribution plate 140. When the maximum width D1 of the distribution plate auxiliary apparatus 150 is greater than the maximum width D3 of the distribution plate 140, a fluid reaching the central nozzle may be excessively reduced. In addition, when the size of the distribution plate auxiliary apparatus 150 is small, the distribution plate auxiliary apparatus 150 may be suspended from the circular rods described above without an excessive load, and thus the reliability of fixing the distribution plate auxiliary apparatus 150 within the drying duct 120 may be improved.

In another example, when the end of the distribution plate auxiliary apparatus 150 is welded to the inner wall of the drying duct 120, the maximum width of the distribution plate auxiliary apparatus 150 may be greater than the maximum width of the distribution plate 140. However, when the end of the distribution plate auxiliary apparatus 150 is welded and fixed only to the inner wall of the drying duct 120 in the transverse direction (i.e., in the y direction), the distribution plate auxiliary apparatus 150 may be provided with holes so that the fluid reaching the central nozzle (e.g., Noz04 or Noz05) via the distribution plate auxiliary apparatus is not excessively reduced. In another example, the distribution plate auxiliary apparatus 150 may be configured such that the width of the distribution plate auxiliary apparatus 150 in the longitudinal direction (i.e., in the x direction) as viewed from above is greater than the maximum width of the distribution plate 140, and the width of the distribution plate auxiliary apparatus 150 in the transverse direction (i.e., in the y direction) is smaller than the maximum width of the distribution plate 140, such that a portion of the fluid may be distributed in the transverse direction of the drying duct 120 to reach the central nozzle (e.g., Noz04 or Noz05).

Referring to FIG. 3, in the drying furnace 100, the centers of the distribution plate 140 and the distribution plate auxiliary apparatus 150 may overlap with the center of the drying duct 120, such that the fluid flowing within the drying duct 120 is more uniformly distributed onto the plurality of nozzles 130 than in embodiments where the centers of the distribution plate 140 and the distribution plate auxiliary apparatus 150 do not overlap with the center of the drying duct 120. In other embodiments, the centers of the supply pipe 110, the distribution plate 140, and the distribution plate auxiliary apparatus 150 may overlap with the center of the drying duct 120, such that the fluid flowing from the supply pipe 110 is more uniformly distributed than in embodiments where the centers of the supply pipe 110, the distribution plate 140, and the distribution plate auxiliary apparatus 150 do not overlap with the center of the drying duct 120.

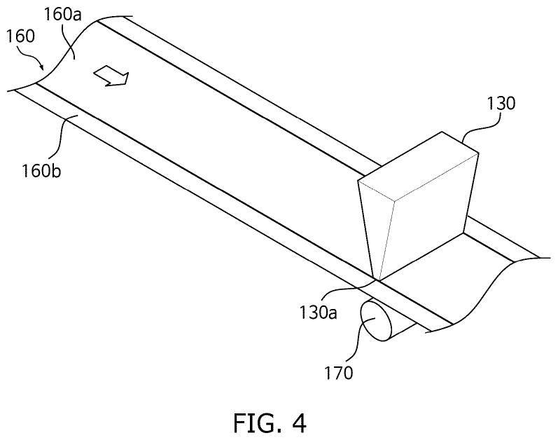

FIG. 4 is an isometric view partially of the nozzles and the electrode according to embodiments of the present disclosure. FIG. 4 partially illustrates only one nozzle 130 of a plurality of nozzles connected to the bottom of the drying duct of the drying furnace (e.g., 100 in FIG. 1).

A plurality of holes may be perforated in the bottom 130a of each of the plurality of nozzles 130 of the drying furnace. Because it is difficult to uniformly distribute fluid to the ends within the drying duct due to the drying duct extending in the longitudinal direction (i.e., in the x direction), the plurality of nozzles 130 may be configured such that a perforated plate may be provided at the bottom surface 130a of each of the plurality of nozzles 130. The perforated plate may be a plate in which, for example, a plurality of circular through-holes are randomly formed. In another example, a plurality of striped through-holes may be arranged in a direction parallel to the transverse direction of the bottom of the drying duct. However, the hole shape and the number of holes of the perforated plate are not limited, but the perforated plate may be configured such that the holes are not formed unevenly in the transverse direction of a composite portion 160a in order to prevent the composite portion 160a from being dried unevenly in the transverse direction. Accordingly, a problem such as overdrying the edge portion of the composite part 160a may be prevented.

For example, the striped through-holes may be spaced apart at regular intervals to uniformly distribute fluid within the lower duct. A shorter separation distance between the through-holes may result in a greater resistance of the lower duct of flow onto the electrode plate 160. Accordingly, a large amount of flow may not be sprayed at once, and fluid having a reduced flow rate may pass through the through-holes of each of the plurality of nozzles 130 described above after being distributed within the lower duct.

The electrode plate 160, which is an object to be dried in the electrode plate drying furnace, may include an electrode substrate 160b and the composite portion 160a applied to the electrode substrate 160b. A portion of the electrode substrate 160b other than the portion to which the composite portion 160a is applied may be referred to as an uncoated portion. Most of the composite portion 160a may be disposed substantially at the center in the transverse direction of the electrode plate 160, and the uncoated portion may be provided on an edge in the transverse direction. The electrode plate drying furnace may dry the composite portion 160a on the electrode substrate 160b transported by the conveyance rollers 170, and the electrode substrate 160b may include the composite portion 160a and the uncoated portion respectively provided in the transport direction (e.g., the x direction of FIG. 1).

The plurality of nozzles 130 may be at the bottom of the drying duct of the drying furnace to supply fluid to the composite portion 160a. The length of the plurality of nozzles 130 in the longitudinal direction may be equal to or longer than the length of the composite portion 160a in the transverse direction. Accordingly, the plurality of nozzles 130 may be designed to allow the composite portion 160a to be dried in the entire transverse direction by the fluid supplied from the plurality of nozzles 130. In particular, a length of each of the plurality of nozzles 130 in the longitudinal direction being greater than a length of the composite portion 160a in the transverse direction may address, at least partially, an edge portion of the composite portion 160a not being sufficiently dried due to insufficient fluid reaching a periphery in the transverse direction within the drying duct.

The plurality of nozzles 130, as described above, may be in a plurality at the bottom of the drying duct and spaced apart from each other by set intervals in the longitudinal direction of the proceeding electrode plate 160 to provide uniform fluid to the composite portion 160a in the longitudinal direction. In addition, each of the plurality of nozzles 130 may be elongated in the transverse direction of the electrode plate 160 to provide uniform fluid in the transverse direction of the composite portion 160a.

As shown in FIG. 4, each of the plurality of nozzles 130 may have a cross-sectional area that decreases as the composite portion 160a approaches the applied electrode substrate 160b. A nozzle of the plurality of nozzles 130 may be configured such that the cross-sectional area thereof continuously decreases from the bottom of the lower duct to the bottom of the nozzle of the plurality of nozzles 130. Thus, the fluid in the lower duct may be sprayed at a higher pressure when sprayed onto the electrode plate 160 through the nozzle of the plurality of nozzles 130. Accordingly, the flow rate at the bottom of the nozzle of the plurality of nozzles 130 may be set to be equal to or higher than a predetermined standard value, thereby improving a drying performance of the drying furnace.

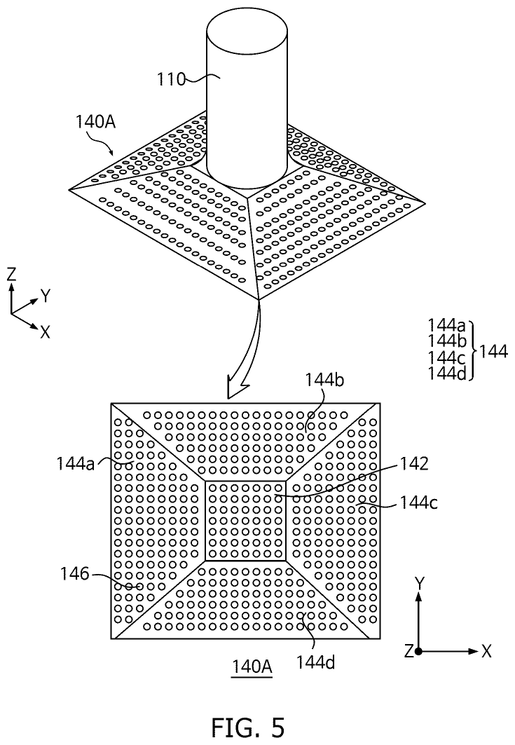

FIG. 5 shows an isometric view of a supply pipe and a distribution plate and a top view of the distribution plate according to embodiments of the present disclosure. An upper portion of FIG. 5 is a perspective view showing the supply pipe 110 and a distribution plate 140A connected to the supply pipe 110, and a lower portion of FIG. 5 is a top view showing the distribution plate 140A viewed from above.

Referring to FIG. 5, the distribution plate 140A of the electrode plate drying furnace (e.g., 100 of FIG. 1) may include a connection surface 142 connected to the lower end of the supply pipe 110 and inclined surfaces 144 surrounding the connection surface 142 and connected to and inclined downward from the connection surface 142. In addition, the distribution plate 140A may include a plurality of holes 146, as shown in FIG. 5, or may not include a plurality of holes (not shown). The plurality of holes 146 may be a plurality of circular holes, as shown in FIG. 5, or striped holes, as shown in FIGS. 1 and 2, but a shape of the holes 146 is not limited. The holes 146 may be provided to directly supply at least a portion of fluid introduced into the drying duct through the supply pipe 110 to a position below the distribution plate 140A. The holes 146 may be provided in both the connection surface 142 and the inclined surfaces 144 or may be provided only in the connection surface 142. In another example, the holes 146 may be provided only in the inclined surfaces 144. However, the holes 146 may not be provided in boundaries between the connection surface 142 and the inclined surfaces 144 of the distribution plate 140A, which may prevent the connection surface 142 and the inclined surfaces 144 from being separated by a pressure of the fluid or may prevent the boundaries from being broken or damaged.

Forming the holes 146 in surfaces of the connection surface 142 other than the portions connected to the supply pipe 110 may improve the reliability of fixing the lower end of the supply pipe 110 and the connection surface 142 via welding or the like.

When the holes 146 are formed only in the connection surfaces 142 of the distribution plate 140A, at least a portion of the fluid introduced into the drying duct through the supply pipe 110 may form a flow connected to a position below the distribution plate 140A through the holes 146 in the connection surface 142.

When the holes 146 are provided only in the inclined surfaces 144 of the distribution plate 140A, at least a portion of the fluid introduced through the supply pipe 110 may form a flow connected to the position below the distribution plate 140A through the holes 146 in the inclined surfaces 144. Embodiments in which the holes 146 are formed only in the connection surface 142 may form a larger flow connected to the position below distribution plate 140A than embodiments in which the holes 146 are formed only in the inclined surfaces 144.

When none of the holes 146 are provided in the distribution plate 140A, only a very small flow may be formed below the distribution plate 140A, and a high degree of fluid distribution may be achieved by the distribution plate 140A.

In some embodiments, the connection surface 142 of the distribution plate 140A may have a shape of a plate to be connected to the lower end of the supply pipe 110 by welding or the like and may have a circular shape or a rectangular shape as shown in FIG. 5, but the shape of the distribution plate 140A in other embodiments is not limited to the aforementioned description.

Referring to FIG. 5, when the connection surface 142 is a square plate, the inclined surfaces 144 surrounding the connection surface 142 may include a first inclined surface 144a and a third inclined surface 144c coupled to the connection surface 142 in the longitudinal direction of the drying furnace (i.e., in the x direction). The inclined surfaces 144 may further include a second inclined surface 144b and a fourth inclined surface 144d coupled to the connection surface 142 in the transverse direction of the drying furnace (i.e., in the y direction). The first inclined surface 144a and the third inclined surface 144c may protrude the same length from the connection surface 142. In another example, the second inclined surface 144b and the fourth inclined surface 144d may protrude the same length from the connection surface 142.

The degree of inclination of the inclined surfaces 144 connected to and inclined downward from the connection surface 142 may vary depending on a size of the drying duct, of which “downward” may refer to the height direction of the drying duct (i.e., the negative z direction). For example, when a length of the drying duct in the longitudinal direction (i.e., in the x direction) is relatively long, a degree to which the inclined surfaces 144 are inclined downward may be designed to be relatively small to increase the degree to which the fluid is distributed. In another example, when the length of the drying duct in the longitudinal direction (i.e., in the x direction) is relatively short, the degree to which the inclined surfaces 144 are inclined downward may be designed to be relatively large, because it is sufficient to have a small degree of fluid distribution.

The distribution plate 140A may be disposed within the upper duct of the drying duct. In another example, the distribution plate 140A may be provided across the upper and lower ducts of the drying duct. The position of the distribution plate 140A may vary depending on the length of the supply pipe 110 protruding into the drying duct to which the distribution plate 140A is fixed.

Fluid introduced into the drying duct through the supply pipe 110 may first pass by the distribution plate 140A, and the distribution plate 140A may serve to distribute the fluid widely. The distribution plate 140A allows the fluid to be distributed along the space of the upper duct. For example, the fluid may reach the inner surface of the upper duct to be supplied to the peripheral portions of the drying duct in both the longitudinal direction and the transverse direction.

When the distribution plate 140A has the holes 146, at least a portion of the fluid introduced through the supply pipe 110 may flow through the holes 146 in the distribution plate 140A to form a strong flow toward the position below the distribution plate 140A.

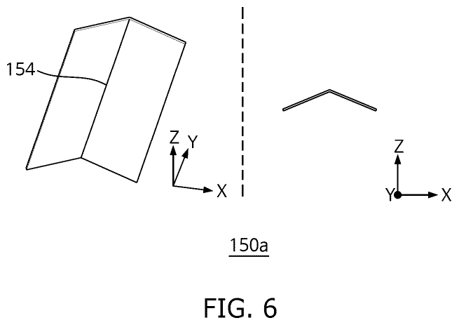

FIG. 6 is a perspective view of a distribution plate auxiliary apparatus folded about a centerline according to some embodiments of the present disclosure. The left part is a perspective view of the distribution plate auxiliary apparatus, and the right part is a side view of the distribution plate auxiliary apparatus in the longitudinal direction of the drying furnace (i.e., in the x direction).

The distribution plate auxiliary apparatus may have a plate-shaped structure. When the distribution plate auxiliary apparatus has a plate-shaped structure, a direction of distribution of at least a portion of fluid that has passed through the distribution plate may be changed.

The distribution plate auxiliary apparatus may have a plurality of holes. The holes may be circular holes or striped holes, but the shape and the number of the holes are not particularly limited. The holes may be provided to prevent a provision of the distribution plate auxiliary apparatus from increasing the resistance to the fluid flow. The holes may not be formed when the distribution plate auxiliary apparatus is streamlined or when the distribution plate auxiliary apparatus has a small size and, thus, does not excessively increase a resistance to the fluid flow.

The distribution plate auxiliary apparatus 150a may be folded about a centerline 154 passing through a central portion of the distribution plate auxiliary apparatus 150a toward an electrode substrate to which a composite portion for the electrode plate is applied. The centerline 154 may be parallel to the transverse direction of the electrode plate drying furnace (i.e., to the y direction). Referring to the right-side view, the extent to which the distribution plate auxiliary apparatus 150a is folded in the negative z direction toward the electrode substrate (to which the composite portion for the electrode plate is applied) may vary depending on the length of the drying duct in the longitudinal direction (i.e., in the x direction). For example, when the length of the drying duct in the longitudinal direction (i.e., in the x direction) is long, and it is desired to increase a degree of distribution of fluid that has passed through the distribution plate, a degree of folding of the distribution plate auxiliary apparatus 150a may be relatively small.

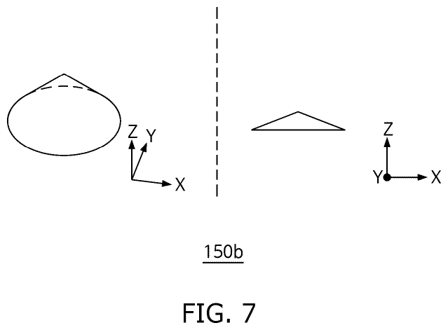

FIG. 7 is a perspective view of a distribution plate auxiliary apparatus having a conical shape according to some embodiments of the present disclosure. The distribution plate auxiliary apparatus 150b may have a conical shape, which is recessed in the z-direction or in a direction opposite to the direction toward the electrode substrate to which the composite portion for the electrode plate is applied. Referring to the side view on the right, the degree of inclination of the side surface of the cone may vary depending on the size of the drying duct. For example, when the size of the drying duct is relatively large, a degree of inclination of the side surface of the cone may be small to increase the degree of distribution of fluid that has passed through the distribution plate.

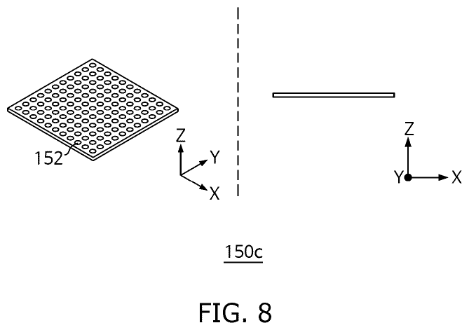

FIG. 8 is a perspective view of a distribution plate auxiliary apparatus having a rectangular plate-shaped structure according to some embodiments of the present disclosure. The distribution plate auxiliary apparatus 150c may be a rectangular plate-shaped structure. The distribution plate auxiliary apparatus 150c having the shape of a plate-shaped structure without sloped areas may provide high resistance to fluid flowing through the distribution plate. Accordingly, a plurality of holes 152 may be provided to penetrate the plate-shaped structure, as shown in FIG. 8.

The distribution plate auxiliary apparatus described above may be designed to have other different structures to improve a distribution performance.

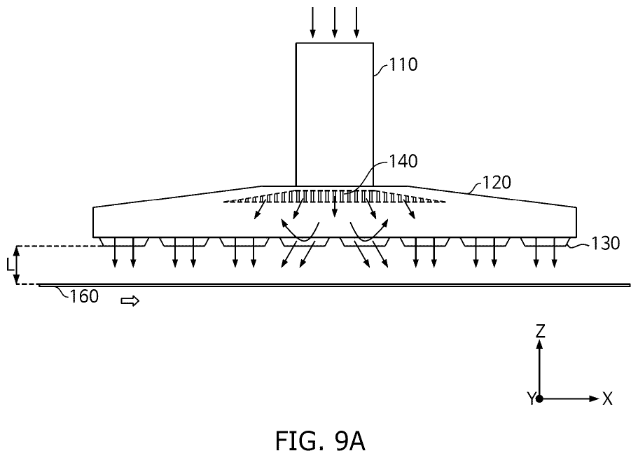

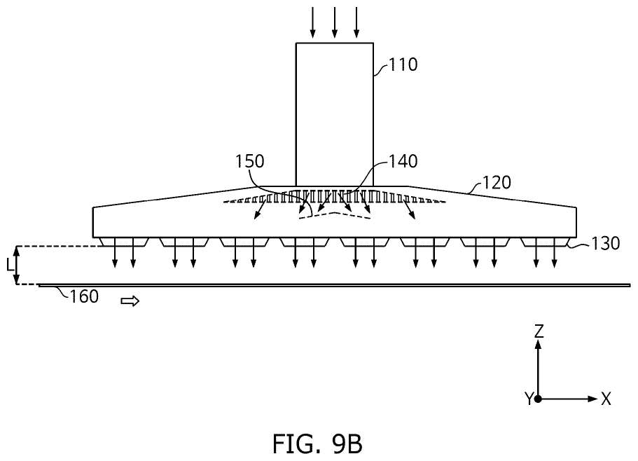

FIG. 9A is a schematic view of fluid flow in the electrode plate drying furnace according to some embodiments of the present disclosure. Arrows indicate the direction of fluid flow in the drying furnace (e.g., 100 of FIG. 1). The electrode plate 160 is transported by the conveyance rollers, which are omitted from the figures for ease of a description.

The distribution plate 140 shown in FIG. 5 may be disposed in the central portion of the drying furnace. For example, the distribution plate 140 may be disposed above the central nozzle of the plurality of nozzles 130 arranged in the longitudinal direction of the drying furnace.

Fluid introduced through the supply pipe 110 may be at least partially distributed within the drying duct 120 by the distribution plate 140 connected to the lower end of the supply pipe 110. Thus, the direction of the fluid flow introduced from supply pipe 110 may be changed.

However, at least a portion of the fluid introduced by the distribution plate 140 may accumulate in the central portion below the distribution plate 140. As the fluid flow becomes strong, a large fluid flow may pass through the plurality of nozzles 130 below the distribution plate 140, such as the central nozzle in the longitudinal direction of the drying furnace (i.e., in the x direction). In addition, a perforated plate may be disposed at the bottom of a nozzle of the plurality of nozzles 130 to provide significant resistance. In another example, when fluid flows through the central nozzle at a large flow rate and a high flow velocity, and when the central nozzle has a large width, the resistance at the bottom surface of the nozzle of the plurality of nozzles 130 may be increased, thereby resulting in a backflow of fluid accumulated in the central nozzle, as shown in FIG. 9A.

As described above, as a large flow rate of fluid accumulates in the central nozzle, a fluid flow within the central nozzle may flow down the side surfaces of the plurality of nozzles 130 and may be sprayed onto the electrode plate 160 in inclined directions. In this case, the amount of fluid sprayed onto the electrode plate 160 transported to the position below the central nozzle may be relatively small.

To increase the drying performance of the drying furnace, the distance L between the bottom of the nozzle of the plurality of nozzles 130 and the electrode plate 160 may be relatively short. Therefore, as the fluid contacts the electrode plate 160 before the fluid flow is sufficiently developed after passing through the drying duct 120, a phenomenon of uneven drying due to uneven fluid flow may occur. The above problem may be remedied by configuring the nozzles of the plurality of nozzles 130 to lower the flow velocity of the fluid below the nozzles of the plurality of nozzles 130.

FIG. 9B is another schematic view of fluid flow in the electrode plate drying furnace according to some embodiments of the present disclosure. Arrows indicate the direction of fluid flow in the drying furnace (e.g., 100 of FIG. 1). The electrode plate 160 is transported by the conveyance rollers, which are omitted from the figures for ease of description.

The distribution plate auxiliary apparatus 150 may be an apparatus, as shown in FIG. 6 and may be further disposed between the distribution plate 140 and the central nozzle, and the other conditions are the same as the configuration shown in FIG. 9A.

The fluid introduced through the supply pipe 110 may be at least partially distributed within the drying duct 120 by the distribution plate 140 connected to the lower end of the supply pipe 110. In addition, a plurality of holes may be provided in the distribution plate 140, as shown in FIG. 5, such that at least a portion of the introduced fluid accumulates below the distribution plate 140 and may be distributed in the longitudinal direction of the drying duct (i.e., in the x direction) by a distribution plate auxiliary apparatus 150 having no holes. As shown in FIG. 9A, a degree to which the direction of fluid flow is changed may be large compared to when only the distribution plate 140 is provided. Accordingly, the amount of fluid flow that accumulates in the central portion below the distribution plate 140 may be less and the flow rate of the fluid may be slower. Accordingly, the flow rate through the central nozzle may be reduced, and the resistance provided by the plurality of nozzles 130 and the perforated plate disposed below the plurality of nozzles 130 may be weaker, thereby reducing the frequency of an occurrence of fluid backflow at the bottom of nozzles of the plurality of nozzles 130, as shown in FIG. 9A.

In addition, referring to FIG. 9B, the flow rate of the fluid passing through each of the plurality of nozzles 130 may be substantially similar, and a large amount of fluid may not accumulate in the central nozzle, thereby preventing the fluid from flowing down the side surfaces of the central nozzle.

Furthermore, even when the distance L between the bottom of the nozzles of the plurality of nozzles 130 and the electrode plate 160 is relatively short in order to increase the drying performance of the drying furnace, the fluid may be uniformly distributed and the flow velocity at the lower surface of the nozzles of the plurality of nozzles 130 may be low enough to allow sufficient flow development before reaching the electrode plate 160, as described above.

The electrode plate drying furnace may include: a supply pipe 110 through which fluid is introduced from outside, a drying duct 120 connected to the supply pipe 110 and configured to allow fluid to move therethrough, conveyance rollers configured to transport an electrode substrate to which a composite portion for an electrode plate is applied in a longitudinal direction of the bottom of the drying duct 120 in a state where the electrode substrate is spaced apart from the bottom of the drying duct 120, and a plurality of nozzles 130 arranged in the longitudinal direction of the bottom of the drying duct 120 and configured to spray at least a portion of the fluid toward the electrode substrate being transported. The electrode plate drying furnace may also include (i) a distribution plate 140 including, within the drying duct 120, a connection surface connected to the lower end of the supply pipe 110 and inclined surfaces surrounding the connection surface and connected to and inclined downward from the connection surface and configured to distribute the fluid in a direction toward the plurality of nozzles 130 and (ii) a distribution plate auxiliary apparatus 150 disposed between the distribution plate 140 and at least one of the plurality of nozzles 130 within the drying duct 120 and configured to change the direction of distribution of at least a portion of the distributed fluid.

The flow distribution characteristics of the fluid within the electrode plate drying furnace (e.g., the electrode plate drying furnace 100 of FIG. 1) were evaluated by measuring the flow velocity of the fluid. Specifically, the flow velocity (m/s) at the bottom of each of the plurality of nozzles 130 arranged in the longitudinal direction of the drying furnace (i.e., in the x direction) was measured, and the standard deviation (Std.) of the measured values of each nozzle of the plurality of nozzles 130 was calculated and shown in Table 1 below.

Comparative Example 1 is an electrode plate drying furnace in which neither the distribution plate 140 nor the distribution plate auxiliary apparatus 150 is provided, Example 1 is an electrode plate drying furnace in which the distribution plate auxiliary apparatus 150 is not provided and only the distribution plate 140 is provided, and Example 2 is an electrode plate drying furnace in which both the distribution plate 140 and the distribution plate auxiliary apparatus 150 are provided.

TABLE 1

| | Noz01 | Noz02 | Noz03 | Noz04 | Noz05 | Noz06 | Noz07 | Noz08 | Std. |
|---|---|---|---|---|---|---|---|---|---|
| Comp. | 2.216 | 2.002 | 2.640 | 5.733 | 5.748 | 2.668 | 2.034 | 2.297 | 0.475 |
| Ex. 1 | | | | | | | | | |
| Ex. 1 | 2.727 | 2.187 | 2.177 | 4.591 | 4.700 | 2.221 | 2.207 | 2.748 | 0.342 |
| Ex. 2 | 2.488 | 2.196 | 2.191 | 2.705 | 2.704 | 2.198 | 2.222 | 2.565 | 0.090 |

Referring to Table 1, it may be seen that the flow velocity at the bottom of the central nozzles Noz05 and Noz06 is higher than the flow velocity at the bottom of the other peripheral nozzles 130 in the drying furnaces of Comparative Example 1, Example 1, and Example 2, as described above.

Referring to Table 1, the standard deviation of Example 1 is reduced by about 28% when compared to the standard deviation of Comparative Example 1, therefore indicating that the distribution characteristics of the fluid flow are improved. Furthermore, the standard deviation of Example 2 is reduced by about 81% when compared to the standard deviation of Example 1, therefore indicating that the distribution characteristics of the fluid flow is further improved.

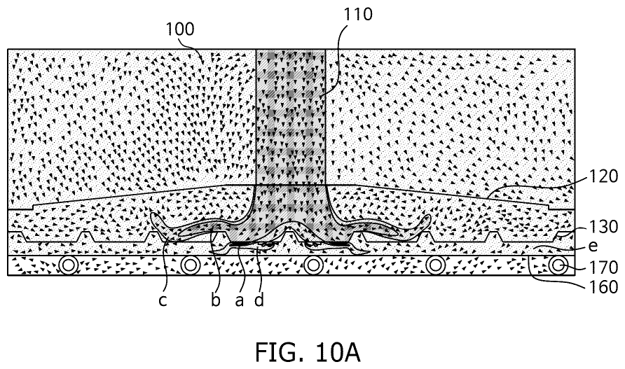

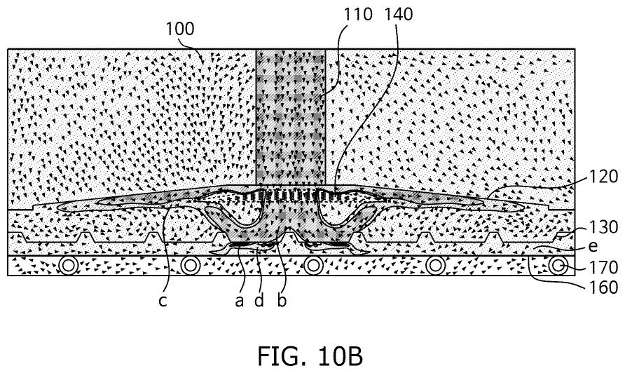

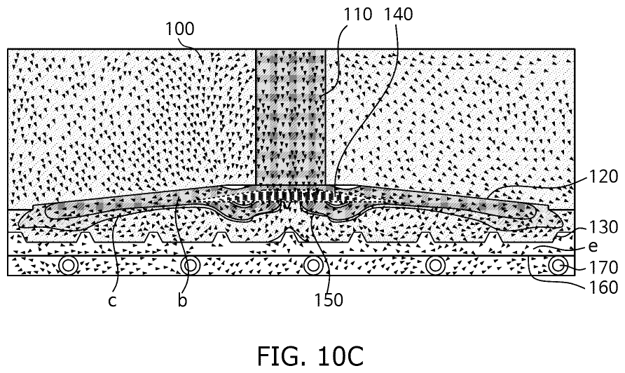

FIGS. 10A to 10C each are a vector field of a fluid flow and flow velocity in the electrode plate drying furnace according to some embodiments of the present disclosure. FIGS. 10A to 10C illustrate the results of evaluating flow fields and vector fields of fluid flow within and below the drying duct 120 of the electrode plate drying furnace 100. FIG. 10A illustrates the evaluation results in Comparative Example 1 (described above with reference to FIGS. 9a to 9b), FIG. 10B illustrates the evaluation results in Example 1, and FIG. 10C illustrates the evaluation results in Example 2.

The direction of the fluid flow is represented by triangular pointers, and the flow velocity of the fluid is divided into five areas corresponding to the respective flow velocities. The flow velocity is divided into: an area of flow velocity exceeding about 4 m/s (i.e., area a), an area of flow velocity of about 3.2 m/s or more and less than 4 m/s (i.e., area b), an area of flow velocity of about 2.8 m/s or more and less than 3.2 m/s (i.e., area c), an area of flow velocity of about 1.2 m/s or more and less than 2.8 m/s (i.e., area d), and an area of flow velocity of about 1.2 m/s or less (i.e., area e).

A main flow of fluid introduced from the supply pipe 110 is formed as shown in area b and is concentrated in the central nozzles Noz04 and Noz05. In addition, a backflow from the central nozzles Noz04 and Noz05 is formed as shown in area b and area c, and the backflow moves to the adjacent nozzles Noz03 and Noz06. The direction of fluid flow within the nozzles in area b and area c are either a direction inclined downward along the inner surface of the central nozzles Noz04 and Noz05 or a direction of backflow from bottoms of the nozzles of the plurality of nozzles 130 Noz03, Noz04, Noz05, and Noz06.

Referring to FIG. 10A, in the space between the plurality of nozzles 130 and the electrode plate 160, a flow is formed at the bottoms of the central nozzles Noz04 and Noz05 as shown in area a, and a direction of the fluid flow in area a is a direction outwardly inclined with respect to the electrode plate 160. Furthermore, at a position away from the bottoms of the central nozzles Noz04 and Noz05 toward the electrode plate 160, the flow rate slows down to form area d, and the direction of the fluid flow in area d is a direction inclined outward with respect to the electrode plate 160. Thus, the electrode plate 160 disposed below the central nozzles Noz04 and Noz05 may be insufficiently dried.

Referring to FIG. 10B, a main flow of fluid introduced from the supply pipe 110 is formed as shown in area b. A portion of area b is formed in an upper portion of the inside of the drying duct 120, and the distribution plate effects a distribution of the fluid. The remaining portion of area b is concentrated in the central nozzles Noz04 and Noz05. A backflow from the central nozzles Noz04 and Noz05 is formed in area b and area c, and the backflow is moved to the upper portion of the inside of the drying duct 120. The direction of the fluid flow in area b and area c is a direction inclined downward along the inner surface of the central nozzles Noz04 and Noz05 or a direction of backflow from the bottoms of the central nozzles Noz04 and Noz05.

In the space between the plurality of nozzles 130 and the electrode plate 160, a flow is formed at the bottoms of the central nozzles Noz04 and Noz05 in area a, and a direction of fluid flow in area a is a direction inclined outward with respect to the electrode plate 160. Furthermore, at a position toward the electrode plate 160 away from the bottoms of the central nozzles Noz04 and Noz05, the flow rate slows down to form area d, and the direction of the fluid flow in area d is a direction inclined outward with respect to the electrode plate 160.

Referring to FIG. 10C, a main flow of fluid from the supply pipe 110 is formed as shown in area b, a portion of area b is formed on the upper portion of the inside of the drying duct 120, and the distribution plate effects a distribution of the fluid. The remaining portion of area b is distributed by the distribution plate auxiliary apparatus 150 disposed between an area above the central nozzles Noz04 and Noz05 and the distribution plate 140. As a result, a main flow is formed as shown in areas b and c, therefore indicating that fluid is supplied uniformly at a relatively constant flow rate to the entirety of the plurality of nozzles 130. In addition, there is neither a flow in a downwardly inclined direction along the inner surfaces of the central nozzles Noz04 and Noz05 nor a backflow from the bottoms of the central nozzles Noz04 and Noz05.

In the space between the plurality of nozzles 130 and the electrode plate 160, a flow is formed at the bottoms of the central nozzles Noz04 and Noz05 as shown in area e, therefore indicating that the fluid was uniformly sprayed on the entire electrode plate 160 at the bottom of the drying furnace 100.

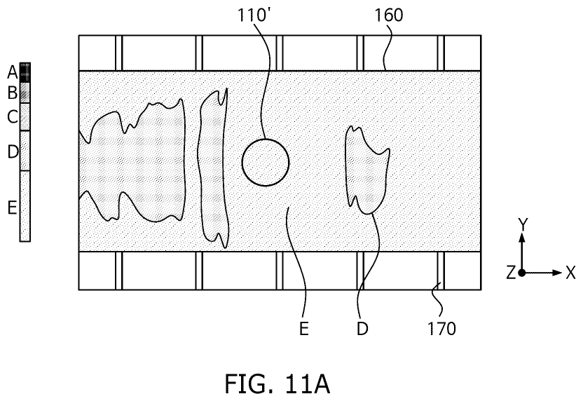

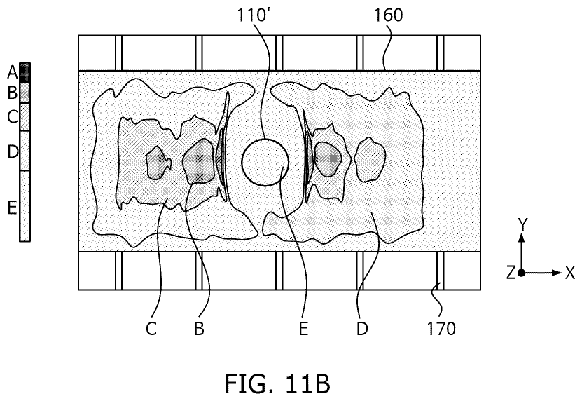

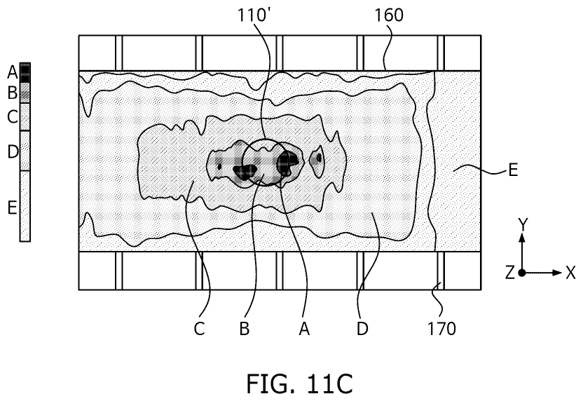

FIGS. 11A to 11C each are a pressure field on the surface of the electrode plate of the drying furnace according to some embodiments of the present disclosure. FIGS. 11A to 11C illustrate the results of measuring and comparing pressures applied to the electrode plate 160 of the drying furnace shown in FIGS. 10A to 10C by fluid sprayed onto the electrode plate 160 of the drying furnace. FIG. 11A is a pressure field on the surface of the electrode plate 160 of the drying furnace shown in FIG. 10A, FIG. 11B is a pressure field on the surface of the electrode plate 160 of the drying furnace shown in FIG. 10B, and FIG. 11C is a pressure field on the surface of the electrode plate 160 of the drying furnace shown in FIG. 10C.

In FIGS. 11A to 11C, the pressures applied to the surface of the electrode plate 160 transported by the conveyance rollers 170 below a single drying furnace is divided into five separate areas. Area A refers to an area where a pressure is greater than about 9 Pa, area B refers to an area where a pressure is greater than about 8 Pa but less than or equal to 9 Pa, area C refers to an area where a pressure is greater than about 7 Pa but less than or equal to 8 Pa, area D refers to an area where a pressure is greater than or equal to about 4 Pa but less than or equal to 7 Pa, and area E refers to an area where a pressure is less than or equal to about 4 Pa. A higher pressure on the surface of the electrode plate 160 may indicate that drying of the fluid sprayed from the nozzle has been effective.

The area E is formed in the lower portion of the supply pipe or the central portion of the drying furnace in the longitudinal direction (i.e., in the x direction), and the area D is formed in the portion excluding the central portion in the longitudinal direction (i.e., in the x direction). When there is neither the distribution plate nor the distribution plate auxiliary apparatus within the drying furnace, the central portion in the longitudinal direction (i.e., in the x direction) is almost not dried, and the area excluding the central portion is dried first.

Referring to FIG. 11B, the area E is formed in the lower portion of the supply pipe or the central portion of the drying furnace in the longitudinal direction (i.e., in the x direction), the area B is formed in a portion adjacent to the area E in the longitudinal direction, and the area C is formed in a portion surrounding the area B. The area D is formed in a portion surrounding the area C. When the distribution plate is provided within the drying furnace, the drying performance of the electrode plate 160 is improved compared to when the distribution plate is not provided, and drying is more uniform in the longitudinal direction of the electrode plate 160 (i.e., in the x direction).

Referring to FIG. 11C, the area A is formed in the lower portion of the supply pipe or the central portion of the drying furnace in the longitudinal direction (i.e., in the x direction), the area B is formed in a portion surrounding the area A, the area C is formed in a portion surrounding the area B, and the area D is formed in a portion surrounding the area C. The area E is formed in a portion surrounding the area D. When the distribution plate and the distribution plate auxiliary apparatus are provided within the drying furnace, the drying performance of the drying furnace is improved, and the electrode plate 160 positioned in the lower portion of the supply pipe or the central portion of the drying furnace in the longitudinal direction (i.e., in the x direction) is sufficiently dried. It may also be seen that most uniform drying is achieved in the longitudinal direction of the electrode plate 160 (i.e., in the x direction).

Although the present disclosure has been described above with respect to embodiments thereof, the present disclosure is not limited thereto. Various modifications and variations can be made thereto by those skilled in the art within the spirit of the present disclosure.

### DESCRIPTION OF REFERENCE SYMBOLS

100: electrode plate drying furnace
110: supply pipe
120: drying duct
120a: upper duct
120b: lower duct
130: nozzle
140: distribution plate
150: distribution plate auxiliary apparatus
160: electrode plate
170: conveyance roller

What is claimed is:

1. An electrode plate drying furnace comprising:
a supply pipe through which a fluid can be introduced;
a drying duct connected to the supply pipe, the drying duct configured to allow the fluid to move therethrough;
a plurality of nozzles connected to a bottom of the drying duct and configured to direct at least a portion of the fluid toward an electrode substrate being transported and to which a composite portion for an electrode plate is applied;
a distribution plate connected to a lower end of the supply pipe within the drying duct, and the distribution plate being configured to distribute the fluid flowing from the supply pipe toward the nozzles; and
a distribution plate auxiliary apparatus disposed between the distribution plate and at least one of the nozzles within the drying duct, the distribution plate auxiliary apparatus being configured to change a direction of distribution of a distributed portion of the fluid.

2. The electrode plate drying furnace as claimed in claim 1, wherein the distribution plate auxiliary apparatus is connected to the lower end of the supply pipe.

3. The electrode plate drying furnace as claimed in claim 1, wherein the distribution plate auxiliary apparatus is connected to an inner wall of the drying duct.

4. The electrode plate drying furnace as claimed in claim 1, wherein the distribution plate auxiliary apparatus includes a plurality of holes.

5. The electrode plate drying furnace as claimed in claim 1, wherein the distribution plate auxiliary apparatus includes a plate-shaped structure.

6. The electrode plate drying furnace as claimed in claim 5, wherein the distribution plate auxiliary apparatus is formed by being folded about a centerline passing through a central portion of the distribution plate auxiliary apparatus so that the distribution plate auxiliary apparatus is folded toward the electrode substrate to which the composite portion for the electrode plate is applied.

7. The electrode plate drying furnace as claimed in claim 6, wherein the centerline is parallel to a transverse direction of the electrode plate drying furnace.

8. The electrode plate drying furnace as claimed in claim 1, wherein the distribution plate auxiliary apparatus has a conical shape that is recessed in a direction opposite to a direction toward the electrode substrate to which the composite portion for the electrode plate is applied.

9. The electrode plate drying furnace as claimed in claim 1, wherein a maximum width of the distribution plate auxiliary apparatus is 0.8 to 1.2 times a diameter of the supply pipe.

10. The electrode plate drying furnace as claimed in claim 1, wherein the distribution plate auxiliary apparatus includes a first distribution plate auxiliary apparatus disposed between the supply pipe and at least one of the nozzles, and a second distribution plate auxiliary apparatus disposed between the first distribution plate auxiliary apparatus and at least one of the nozzles.

11. The electrode plate drying furnace as claimed in claim 1, wherein a maximum width of the distribution plate auxiliary apparatus is less than a maximum width of the distribution plate.

12. The electrode plate drying furnace as claimed in claim 1, wherein the distribution plate includes a plurality of holes.

13. The electrode plate drying furnace as claimed in claim 1, wherein the distribution plate includes a connection surface connected to the lower end of the supply pipe and connected to inclined surfaces surrounding the connection surface, the inclined surfaces being connected to and inclined downward from the connection surface.

14. The electrode plate drying furnace as claimed in claim 1, wherein each of the nozzle includes a plurality of holes at a bottom of the nozzle.

15. The electrode plate drying furnace as claimed in claim 1, wherein the plurality of nozzles is arranged in a longitudinal direction of a bottom of the drying duct.

16. The electrode plate drying furnace as claimed in claim 1, wherein each of the nozzles has a cross-sectional area that decreases in a direction toward the electrode substrate to which the composite portion for the electrode plate is applied.

17. The electrode plate drying furnace as claimed in claim 1, wherein the conveyance rollers are configured to transport the electrode substrate in a longitudinal direction of a bottom of the drying duct when the electrode substrate is spaced apart from the bottom of the drying duct.

18. The electrode plate drying furnace as claimed in claim 16, wherein a length of each of the nozzles in a longitudinal direction is equal to or longer than a length of the composite portion for the electrode plate in a transverse direction.

19. The electrode plate drying furnace as claimed in claim 1, wherein a center of the supply pipe, a center of the distribution plate, and a center of the distribution plate auxiliary apparatus overlap with a center of the drying duct.

20. An electrode plate drying furnace comprising:
a supply pipe through which fluid is introduced;
a drying duct connected to the supply pipe, and configured to allow the fluid to move therethrough;
conveyance rollers configured to transport an electrode substrate to which a composite portion is applied in a longitudinal direction of a bottom of the drying duct when the electrode substrate is spaced apart from the bottom of the drying duct;
a plurality of nozzles arranged in the longitudinal direction of the bottom of the drying duct, the nozzles being configured to direct at least a portion of the fluid toward the electrode substrate being transported;
a distribution plate including, within the drying duct, a connection surface connected to a lower end of the supply pipe and to inclined surfaces, the inclined surfaces surrounding the connection surface and inclining downward from the connection surface, the connection surface and the inclined surfaces configured to distribute the fluid in a direction toward the nozzles; and
a distribution plate auxiliary apparatus disposed between the distribution plate and at least one of the nozzles within the drying duct, the distribution plate auxiliary apparatus being configured to change a direction of distribution of at least a portion of distributed fluid.
